(19) United States
(12) Patent Application Publication
(10) Pub. No.: US 2023/0228271 A1
(43) Pub. Date: Jul. 20, 2023

(54) TWO-STAGE ROTARY VANE VACUUM PUMP CASING

(71) Applicant: Leybold (Tianjin) International Trade Co., Ltd., Tianjin (CN)

(72) Inventors: Li Ouyang, Tianjin (CN); Chuanlei Yang, Tianjin (CN)

(21) Appl. No.: 18/002,377

(22) PCT Filed: Jun. 17, 2021
(86) PCT No.: PCT/IB2021/055358

§ 371 Date: Dec. 19, 2022

(30) Foreign Application Priority Data
Jun. 26, 2020 (WO) PCT/CN2020/098310

(51) Int. Cl. F04C 29/04; F04C 23/00; F04C 25/02

(52) U.S. Cl. CPC F04C 29/04; F04C 23/00; F04C 25/02; F04C 2240/30; F04C 2230/24

(57) ABSTRACT

The present disclosure relates to a two-stage rotary vane vacuum pump casing 200 that comprises an exterior surface 202 and a first plurality of cooling fins 204 (214) protruding from the exterior surface 202, wherein each cooling fin 204 (214) extends along the exterior surface 202 between a first and second cooling fin end 201a, 201b, and is a non-planar element that forms an at least partially enclosed cooling channel 206 (216) between the first and second ends 201a, 201b of the cooling fin 204 (214b). The present disclosure also provides a method of making a two-stage rotary vane vacuum pump casing 200 using extrusion and providing a removable end plate for a two-stage rotary vane vacuum pump casing 200.

### CROSS-REFERENCE OF RELATED APPLICATION

This application is a Section 371 National Stage Application of International Application No. PCT/IB 2021/055358, filed Jun. 17, 2021, and published as WO 2021/260505A1 on Dec. 30, 2021, the content of which is hereby incorporated by reference in its entirety and which claims priority of Chinese Application No. PCT/CN2020/098310, filed Jun. 26, 2020.

### FIELD

This disclosure relates to two-stage rotary vane vacuum pump casings. This disclosure also relates to a method of making such vacuum pump casings and two-stage rotary vane vacuum pumps that incorporate such casings.

### BACKGROUND

In the field of two-stage rotary vane vacuum pumps, it is known to provide the vacuum pumps with casings that define the exterior of the vacuum pump and house its component parts. During vacuum pump operation, the vacuum pump can generate waste heat e.g. due to fluid compression and/or motor/rotary vane actuation therein. This waste heat will often be communicated to the casings of the vacuum pump, where it will dissipate to the surroundings. It is often desirable to dissipate the waste heat from the casings as quickly as possible, in order to prevent build up and retention of waste heat in the vacuum pump and the casings. This is because excessive build up and retention of waste heat may risk damage or increased deterioration to certain vacuum pump components, and may also impact on the service life and efficiency of the vacuum pump.

This waste heat can be particularly prevalent and problematic in two-stage rotary vane pump designs (e.g. compared to other pump designs, such as single-stage pumps). Accordingly, it is known to provide two-stage rotary vane vacuum pump casings with cooling fins formed on an exterior surface thereof. The cooling fins are intended to expose a larger surface area of the casings to the surroundings to encourage heat dissipation therefrom.

The geometry and arrangement of the cooling fins is often limited by the manufacturing processes used to form the casings. This may provide certain limitations on the effectiveness of the casings and cooling fins to dissipate heat from the vacuum pump.

Accordingly, a need exists to provide two-stage rotary vane vacuum pump casings with different cooling fin geometries and arrangements that improve the effectiveness of heat dissipation therefrom, and to employ different methods of manufacture that allow for these to be formed.

A general need also exists to provide improved methods of manufacturing two-stage rotary vane vacuum pump casings.

The discussion above is merely provided for general background information and is not intended to be used as an aid in determining the scope of the claimed subject matter. The claimed subject matter is not limited to implementations that solve any or all disadvantages noted in the background.

### SUMMARY

From one aspect, the present disclosure provides a two-stage rotary vane vacuum pump casing comprising an exterior surface and a first plurality of cooling fins protruding from the exterior surface. Each cooling fin extends along the exterior surface between a first and second cooling fin end, and is a non-planar element that forms an at least partially enclosed cooling channel between the first and second ends of the cooling fin.

The partially enclosed cooling channel formed by the non-planar cooling fins provides a great tendency for cooling fluid entering the cooling fins to be confined and guided between them compared to prior planar elements. This has the advantage of allowing improved amounts of thermal transfer from the casing and cooling fins to the cooling fluid before it is dispersed from the casing.

In some embodiments of this aspect, each cooling fin defines an overhang that extends over the exterior surface to form the at least partially enclosed cooling channel. In some of these embodiments, the cross-section of the cooling fins viewed along the exterior surface is at least one of a T-shape or an L-shape. In certain embodiments, the cross-section may be defined by a planar portion of the cooling fin from which the overhang extends.

In alternative embodiments, the cooling fins define fully enclosed cooling channels that are tubular. In some of these embodiments, the cross-section of the fully enclosed cooling channels viewed along the exterior surface is at least one of a regular closed shape or an irregular closed shape. Exemplary regular closed shapes include square shaped, circular shaped and hexagonal shaped. Exemplary irregular closed shapes may be convex or concave shapes.

The various embodiments discussed above all provide particularly suitable geometries of cooling fins that form the at least partially enclosed cooling channels to achieve the advantages thereof. The geometries can be varied to adjust the degree to which the cooling channel is enclosed and tailor the degree of confinement provided to cooling fluid entering the cooling fins/channels and the amount of ambient cooling fluid around the casing that can interact with the cooling fins/channels.

In further embodiments of any of the above, the cooling fins extend along the exterior surface in a series of rows parallel to each other. In some of these embodiments, the rows of cooling fins extend parallel to a longitudinal axis of the casing from a first end of the casing to an opposing second end of the casing. In such embodiments, the cooling fins start and end at the first and second casing ends, and as such, extend the entirety of the axial length of the casing.

In the above embodiments, the parallel rows and extent of cooling fin extension across the casing can enhance the amount of cooling fluid captured by and guided along the casing by the cooling fins, as well as increase the surface area of casing that can transfer heat to the cooling fluid. It may also provide a suitably pleasing aesthetic to the casing exterior surface.

From another aspect, the present disclosure also provides a two-stage rotary vane vacuum pump casing assembly that comprises the casing of any of the embodiments discussed above and an end plate removably secured to the casing. The end plate is removably secured to an end of the casing.

The removable nature of the end plate allows easier access to the casing interior, which can facilitate maintenance and repair activities for a two-stage rotary vane vacuum pump that includes the casing.

In a further embodiment of the above aspect, a seal is secured between the end plate and the casing end (to which the end plate is removably secured). The seal can be any suitable seal design, such as a gasket or an O-ring.

The seal can advantageously provide a secure fluidic seal between the end plate and the casing to ensure fluid does not leak out from the casing during use. This can be particularly useful in two-stage rotary vane vacuum pump applications where the casing is used to contain fluid during use (e.g. pump lubrication fluid, such as oil).

In further embodiments of any of the above, the end plate further comprises a second plurality of cooling fins protruding from and extending along an exterior surface of the end plate. The second plurality of cooling fins align axially with the first plurality of cooling fins.

By ‘align axially’ it is meant that each of the second plurality of cooling fins extend parallel to and co-axially with a respective one of the first plurality of cooling fins of the casing. Accordingly, the second plurality of cooling fins effectively continue the line of the first plurality of cooling fins across the end plate. This alignment of the first and second plurality of cooling fins may accordingly axially align the at least partially enclosed cooling channels with portions of the exterior surface exposed between the second plurality of cooling fins.

The second plurality of cooling fins can provide increased opportunity for thermal transfer to take place between the end plate and the cooling fluid. The aligned nature of the first and second plurality of cooling fins also allows additional confinement of cooling fluid communicated from the casing to the end plate to improve heat transfer thereto. These features may also maintain a pleasing and consistent aesthetic across both the casing and the end plate.

In some of these embodiments, the second plurality of cooling fins are planar elements that have a tapering portion that taper away from the casing. In other words, the second plurality of cooling fins taper in a direction away from the end of the casing that the end plate is removable attached to (e.g. in the axial direction along the longitudinal axis of the casing). The taper can be in at least one of thickness (i.e. the cooling fins reducing in thickness transverse to the axial direction of the casing) or height (i.e. the cooling fins reducing in height above the exterior surface).

The tapering portion may aid a smooth expulsion of cooling fluid from the end plate, and may contribute to providing improved heat transfer from the extremities of the end plate to the cooling fluid. The tapering portion may also contribute to a more pleasing aesthetic for the end plate.

In further embodiments of any of the above, the end plate comprises a transparent window for checking an oil level.

In two-stage rotary vane vacuum pump applications where the casing is used to contain fluid during use (e.g. pump lubrication fluid) this feature can advantageously facilitate checking of the fluid level. This can help inform pump maintenance or repair decisions.

From another aspect, the present disclosure provides a two-stage rotary vane rotary vane vacuum pump comprising a two-stage rotary vane assembly and the casing or casing assembly from any of the above aspects. The casing is used as an oil casing that surrounds the rotary vane assembly.

Two-stage rotary vane vacuum pumps are well-known in the art to refer generally to vacuum pumps that utilise two stages of rotary vanes fluidically connected in series.

Oil casings for two-stage rotary vacuum pumps are also well-known in the art to refer generally to casings that are designed to retain lubrication oil therein, generally around the two-stage rotary vane assembly of the vacuum pump.

The oil casing of two-stage rotary vane vacuum pumps is one casing that experiences a high level of heat during pump operation, and so is in particular need of the advantages provided by the features of the casing and casing assembly of the aforementioned aspects. Therefore, the oil casing is a particularly suitable implementation of the casing and casing assemblies of the aforementioned aspect.

From another aspect, the present disclosure provides a method of manufacturing a two-stage rotary vane vacuum pump casing that comprises forming the casing by extrusion.

The two-stage rotary vane vacuum pump casing formed by this method can include any of the casing features discussed in the above aspects.

Using extrusion to form the vacuum pump casing advantageously allows the first plurality of cooling fins to be formed (e.g. unlike known die casting methods). Moreover, the extrusion method provides other general advantages for vacuum pump casings, such as: thinner casing walls, better surface finish and lower inherent porosity. These can save weight, production time and raw material used to make the casing, and can also provide further improvement in the thermal transfer and mechanical properties of the casing.

This method is thought to be particularly novel, suitable and beneficial when used to produce an oil casing for a two-stage rotary vane vacuum pump (such as that discussed above).

From a final aspect, the present disclosure also provides a two-stage rotary vane vacuum pump casing comprising a removably attached end plate.

In an embodiment of the above aspect, the end plate is removably attached with fasteners and includes openings for receiving the fasteners.

In further embodiments of any of the above, the end plate comprises a plurality of cooling fins protruding from and extending along an exterior surface of the end plate. In some of these embodiments, the cooling fins are planar elements that have a tapering portion that tapers in an axial direction of the end plate.

In further embodiments of any of the above, the casing is an oil casing for a two-stage rotary vane vacuum pump.

In further embodiments of any of the above, the end plate comprises a transparent window for checking an oil level.

The advantages of the features of this aspect are the same as for those discussed in relation to the end plate of the casing assembly aspect discussed above.

It is thought that known oil casings for two-stage rotary vane vacuum pumps in the art are made according to designs that do not provide separate, removably secured end plates, as discussed above.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF DRAWINGS

One or more non-limiting examples will now be described, by way of example only, and with reference to the accompanying figures in which:

FIG. 1 shows an example of a known two-stage rotary vane vacuum pump casing;

FIG. 2 shows a two-stage rotary vane vacuum pump casing in accordance with an embodiment of the present disclosure;

FIG. 3 shows a cross-section of the two-stage rotary vane vacuum pump casing of FIG. 2 along line A-A;

FIG. 4 shows another cross-section of a two-stage rotary vane vacuum pump casing along line A-A in FIG. 2 in accordance with another embodiment of the present disclosure;

FIG. 5 shows another cross-section of a two-stage rotary vane vacuum pump casing along line A-A in FIG. 2 in accordance with another embodiment of the present disclosure;

FIG. 6 shows an exploded view of a casing assembly in accordance with an embodiment of the present disclosure;

FIG. 7 shows a two-stage rotary vane vacuum pump in accordance with an embodiment of the present disclosure.

### DETAILED DESCRIPTION

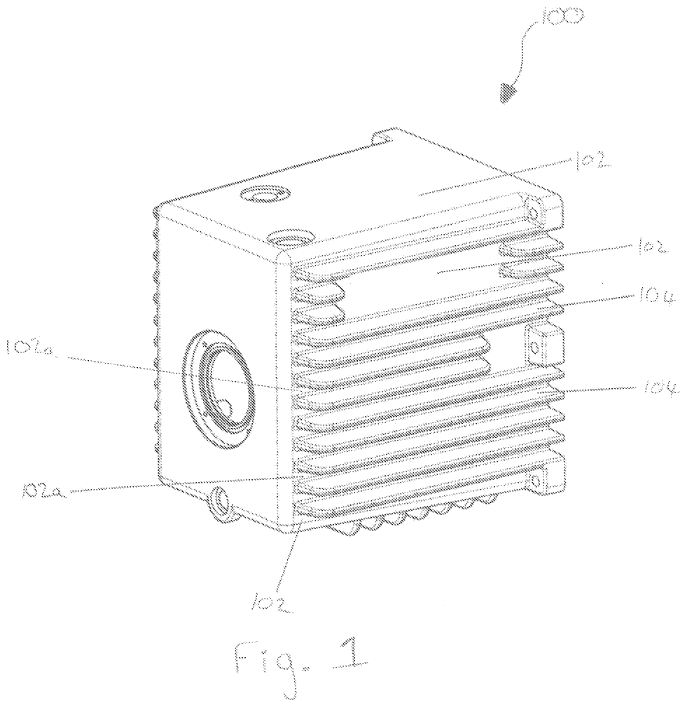

Referring to FIG. 1, an example of a known two-stage rotary vane vacuum pump casing 100 comprising a plurality of cooling fins 104 is shown. The cooling fins 104 are generally planar elements that protrude perpendicularly from an exterior surface 102 of the casing 100. The plurality of cooling fins 104 extend in rows parallel to each other across the exterior surface 102, and adjacent cooling fins 104 are separated from each other by a portion 102a of exterior surface 102 exposed there between. When fluid (e.g. air) surrounding the casing 100 passes over the exterior surface 102 it will flow between and over the cooling fins 104. Accordingly, heat will be transferred thereto from the casing 100. As discussed above, the additional surface area of the casing 100 provided by the cooling fins 104 improves the rate of thermal transfer from the casing 100 to the fluid. This allows greater and quicker heat dissipation to the surroundings compared to a casing without the provision of cooling fins 104.

Until now, the two-stage rotary vane vacuum pump casing 100 has been produced using a die casting process. In this process, a mould cavity is produced which defines the shape of the casing 100. Molten metal is forced under high pressure into the mould cavity and allowed to solidify. The solidified metal is then removed from the cavity to form the casing 100. Due to the need to remove the casing 100 from a mould cavity after solidification, this process has limited the geometry of the cooling fins 104 to the relatively simple shape (e.g. planar protrusions) shown in FIG. 1.

Although the rate of heat dissipation from the casing 100 is improved by the cooling fins 104, it is thought that the more complex geometries of cooling fins provided and enabled by the present disclosure provides further improvements thereon.

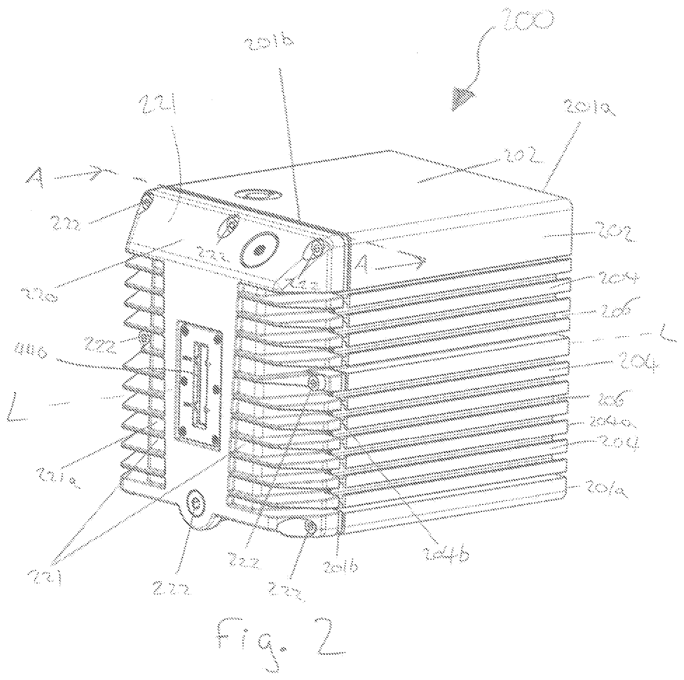

Referring to FIG. 2, a two-stage rotary vane vacuum pump casing 200 is shown according to an embodiment of the present disclosure. The vacuum pump casing 200 comprises an exterior surface 202 and a plurality of cooling fins 204 protruding from the exterior surface 202.

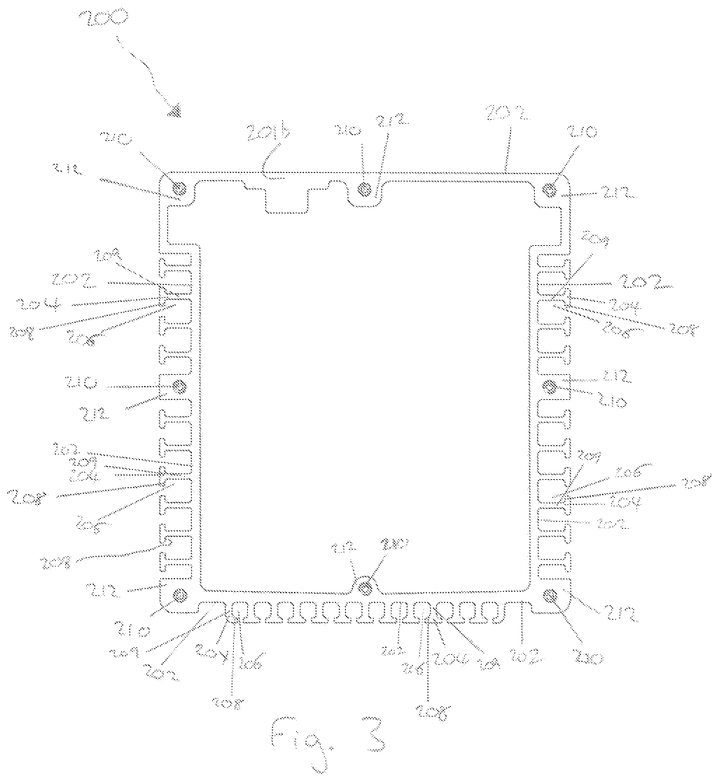

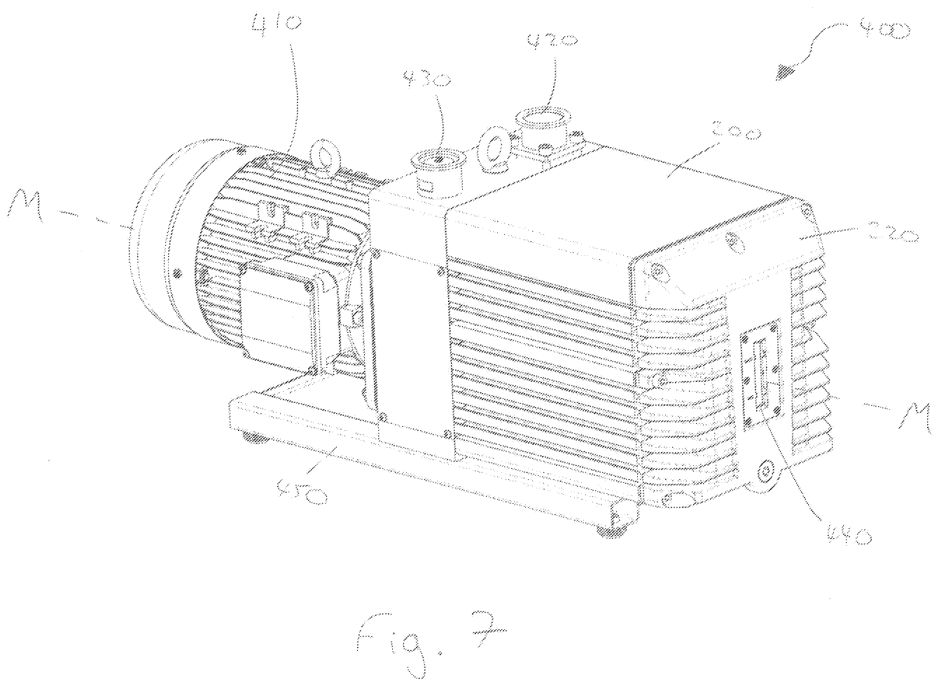

The casing 200 extends along a longitudinal axis L between opposed first and second casing ends 201a, 201b. An end plate 220 is removably attached to the casing 200 via fasteners 222 (discussed in more detail further below in relation to FIG. 6). As shown more clearly in FIG. 3, the casing 200 comprises a plurality of mounting flanges 212 with openings 210 therein, that are configured to accept the fasteners 222 to allow the removable attachment of the end plate 220 to the casing 200 at the second end 201b (e.g. by threaded engagement therewith).

Each cooling fin 204 extends along the exterior surface 202 between a first and second cooling fin end 204a, 204b. In the depicted embodiment, the cooling fins 204 extend in rows, parallel to the longitudinal axis L, and extend between the first and second casing ends 201a, 201b. The cooling fins 204 start and end at the first and second casing ends 201a, 201b and extend the axial length of the casing 200. In this manner, the first and second cooling fin ends 204a, 204b terminate at the first and second casing ends 201a, 201b, respectively.

Unlike the cooling fins 104 of FIG. 1, the geometry of the cooling fins 204 is more complex than a simple planar element protruding from the exterior surface 202. Specifically, each cooling fin 204 is shaped as a non-planar element that forms a partially enclosed cooling channel 206 between the first and second ends 204a, 204b of the cooling fin 204. The partially enclosed cooling channel 206 is configured to confine and guide cooling fluid along the channel 206 between the first and second ends 204a, 204b. In other words, at least a portion of the cooling fluid entering the cooling fins 204 at the first end 204a (e.g. air surrounding the casing 200 or delivered thereto) is confined in the channel 206 formed by the non-planar nature of the cooling fins 204 and proceeds along the axial extent of the cooling fin 204 before exiting at the second cooling find end 204b.

FIG. 3 shows a cross-section of the casing 200 taken along line A-A (i.e. at the second casing end 201b) and viewed down the longitudinal axis L, which shows the geometry of the cooling fins 204 in more detail.

In this embodiment, the non-planar shape of the cooling fins 204 defines an overhang 208 that extends over the exterior surface 202 to form the partially enclosed cooling channel 206. The overhang 208 extends from a planar portion 209 of the cooling fins 204 that extends perpendicularly from the exterior surface 202, thus defining the overall non-planar shape of the cooling fins 204. In this manner, the partially enclosed cooling channel 206 is defined between the overhang 208, planar portion 209 and exterior surface 202.

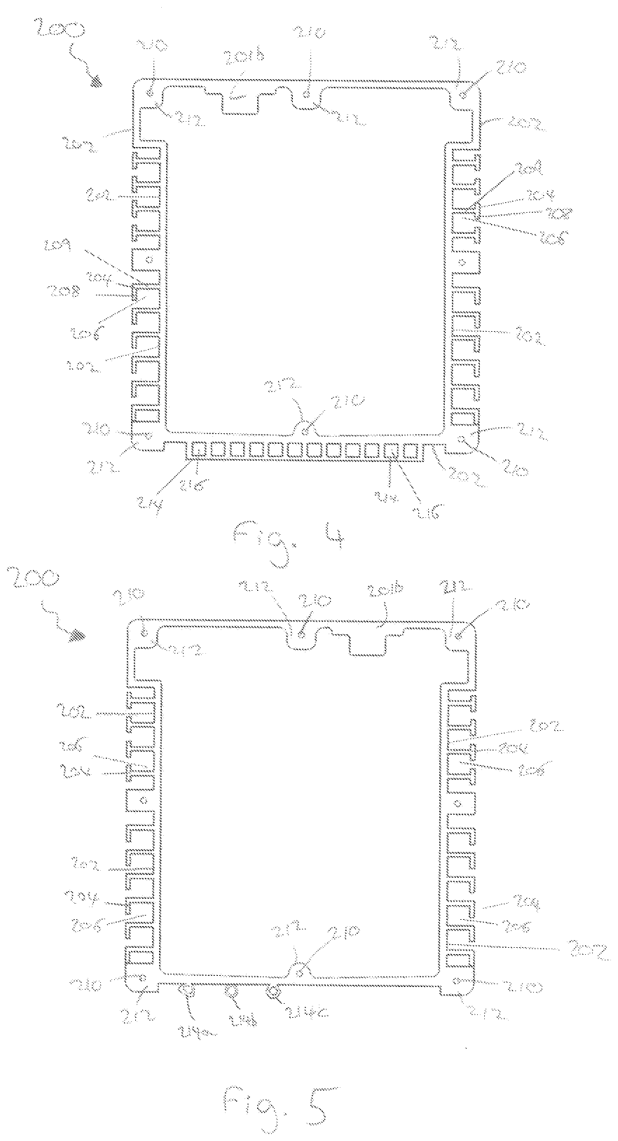

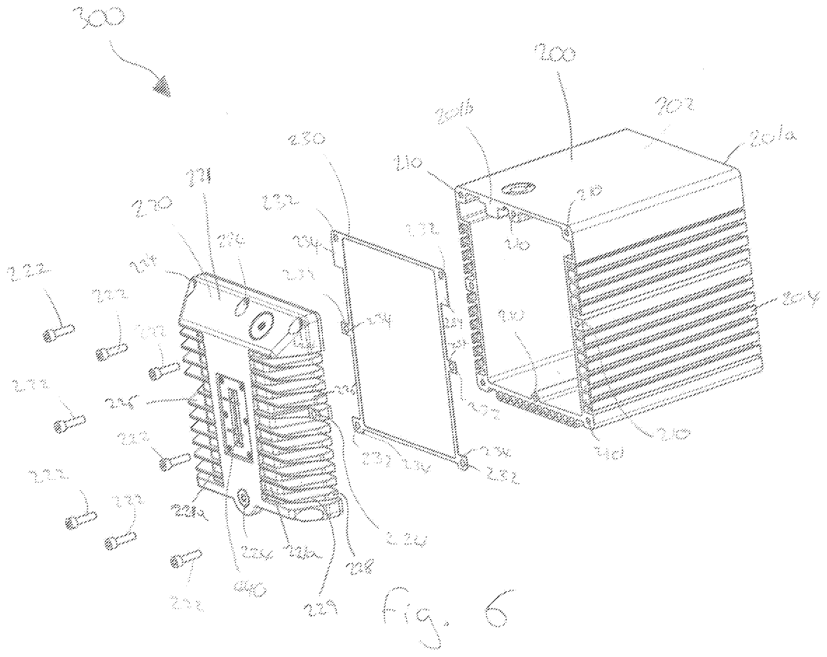

FIGS. 4 and 5 show similar cross-sections of a casing 200 to that of FIG. 3, but for different embodiments of the cooling fins.

As shown across FIGS. 3 to 5, the cooling fins 204 including planar portions 209 and overhangs 208 extending therefrom can be formed to be generally T-shaped and/or L-shaped in cross-section. However, it is to be understood that any other suitable non-planar shape for the cooling fins 204 could be used within the scope of the present disclosure to define a partially enclosed cooling channel 206 using an overhang 208, such as for example generally C-shaped or J-shaped. These also need not extend perpendicular from the exterior surface 202 with a planar portion 209, but could do so at any suitable angle and/or with any suitably shaped portion.

In addition to cooling fins 204 that have similar overhang 208 and planar portion 209 characteristics to those of FIG. 3, another geometry of cooling fins 214 is also shown in FIGS. 4 and 5, in accordance with certain embodiments.

In contrast to the partially enclosed cooling channel 206 defined by cooling fins 204, the cooling fins 214 are shaped to provide fully enclosed cooling channels 216 that extend between respective first and second cooling fin ends in a tubular fashion. Each cooling fin 214 defines an individual, fully enclosed cooling channel 216.

In the embodiment of FIG. 4, each cooling fin 214 is shaped to define a fully enclosed channel 216 of square-cross section. However, as shown in the embodiment of FIG. 5, the cooling fins 214 can also be shaped into other tubular shapes of various cross-sections, including regular or irregular closed shapes. For example, irregular shape 214a, a circular shape 214b and a hexagonal shape 214c. It is also to be understood that any other suitable regular or irregular closed shape cross-section could be used within the scope of this disclosure.

In the embodiment of FIG. 4, it can also be seen that the cooling fins 214 are not spaced from each other (i.e. there is no portion of exterior surface 202 separating each cooling fin 214 row from the next). However, as shown in the embodiment of FIG. 5, the cooling fins 214 can also be spaced from each other with a portion of exterior surface 202 there between. Any suitable spacing can be used, and will be dependent on the amount of cooling fluid flow that is needed between cooling fins 214 for a particular application.

As shown across FIGS. 3 to 5, cooling fins 204, 214 may be used separately across different faces of the exterior surface 202. However, within the scope of this disclosure, the cooling fins 204, 214 could be used in any combination, or may not be combined at all (i.e. the casing 200 only features cooling fins 204 or 214 or only one specific geometry thereof). As will be understood by the skilled person, such design decisions will be dependent upon the particular application, and the amount and rate of heat dissipation needed in specific areas of a casing for that application, or the cooling fluid available thereto.

Without wishing to be bound by theory, it is thought that the partially enclosed cooling channels 206 and fully enclosed cooling channels 216 formed by the cooling fins 204, 214 help confine cooling fluid (e.g. airflow) that enters the cooling fins 204, 214 into thermal contact with the exterior surface 202 of the casing 200 for a longer period of time. This increases the amount of heat that can be transferred to the cooling fluid before it is expelled to the surroundings. In this manner, the cooling fins 204, 214 improve the amount and rate of heat that can be transferred to the cooling fluid and dissipated from the casing 200 compared to the known casing 100 of FIG. 1.

It will be appreciated that the fully enclosed cooling channels 216 may confine the cooling fluid to a greater degree than the partially enclosed cooling channels 206. This can be advantageous when cooling fluid is being delivered directly to the cooling fins 214, as this allows the cooling fluid to absorb more heat from the exterior surface 202 before dispersing. However, it also provides less opportunity for cooling fluid (e.g. air) surrounding the casing 200 to also interact with the exterior surface, and may add extra bulk and weight compared to the partially enclosed cooling channels 206, which provide a compromise in this respect. Nonetheless, both types of cooling fins 204, 214 are advantageous, and as will be understood by the skilled person, can be chosen and mixed as necessary depending on a specific casing application (as discussed above).

It is also to be understood that the size and shape of the cooling fins 204, 214 can be varied as necessary to provide an appropriate amount of cooling fluid communication to the exterior surface and/or degree of confinement there against. For example, in the case of cooling fins 204, they can be shaped such that the overhang 208 provides a more or less enclosed cooling channel 206, and the amount of protrusion of the cooling fins 204 from the exterior surface (e.g. the length of the planar portion 209) can be increased or decreased to vary the amount of cooling fluid that can be accommodated therein. Likewise, the cross-sectional area and size of the channels 216 could be increased and decreased as necessary for a given application.

The embodiments of casing 200 and advantageous non-planar shapes of cooling fins 204, 214 discussed above in relation to FIGS. 2 to 5 are all enabled by departing from the current methods used to manufacture two-stage rotary vane vacuum pump casings. As discussed in relation to FIG. 1, these are currently known to be made using a die casting technique. In the present disclosure, however, it has been found that the vacuum pump casing can be beneficially made using extrusion.

In such an extrusion method, a billet of metal is provided that will be used to form the casing 200. The billet of metal is heated until it has softened a suitable amount (but has not melted). The heated metal is then forced through a die under high pressure, in order to form an extrusion of an appropriate cross-section to form the casing 200. Unlike the mould of die casting, the die of the extrusion method can be shaped to have more complex cross-section shapes, and can therefore be used to produce the casing 200 having cooling fins 204, 214 thereon.

In the exemplary embodiments of this disclosure, the two-stage rotary vane vacuum pump casing 200 is made from aluminium or an alloy thereof, which is generally known to be a suitable material for extrusion. However, any other suitable material may be used within the scope of this disclosure, such as, for example, copper or an alloy thereof.

By using an extrusion method to manufacture the two-stage rotary vane vacuum pump casing 200, not only can the more complex shapes of cooling fins 204 and/or 214 be realised, but also other advantages can be realised.

For example, the extrusion method allows thinner wall thicknesses for the casing 200 to be provided, and likewise thinner thicknesses of cooling fins 204, 214 compared to the conventional die casting method. The thinner thickness may provide a casing 200 that has reduced weight compared to conventional designs. The thinner thicknesses may also improve the rate of thermal transfer through the casing walls and cooling fins 204, 214. In certain embodiments, the wall thickness may be formed between 3-6 mm, although any other suitable wall thickness could also be formed.

The surface finish of the casing 200 may also be improved when using extrusion compared to a die casting method, and may also provide a final casing material that has less inherent porosity (as the metal does not need to undergo melting and re-solidification during manufacture).

Accordingly, it is to be understood that the use of extrusion to manufacture a two-stage rotary vane vacuum pump casing as provided in this disclosure is not just particularly advantageous in order to produce casing 200 with cooling fins 204/214, but may also be advantageous for manufacturing other two-stage rotary vane vacuum pump casings featuring simpler cooling fin geometries (such as those discussed in relation to FIG. 1) or even none at all.

Although extrusion has been found as a particularly suitable method for manufacturing casing 200 with cooling fins 204/214 other methods of manufacture may also be used within the scope of this disclosure. For example, an additive manufacturing technique, such as metal 3D printing, may equally be used.

Such a technique could provide certain advantages compared to extrusion. For example, it could permit cooling fins 204, 214 to be produced in any number of different orientations and lengths across the exterior surface 202 in one manufacturing run, and so even more exotic cooling structures and geometries could be produced. Nonetheless, extrusion may still offer some advantages, such as quicker production time and cheaper designs.

Referring to FIG. 6, an exploded view of a casing assembly 300 including a casing 200 and an end plate 220 is shown. As discussed briefly above in relation to FIG. 2, unlike conventional die cast designs (such as in FIG. 1), the embodiments of the present disclosure permit end plate 220 to be removably attached to the casing 200. To this end, end plate 220 includes openings 224 which allow the threads of the fasteners 222 to pass through and be received (e.g. by co-operating threads) in the corresponding openings 210 of the casing 200.

The assembly 300 includes a seal 230, which is depicted as a gasket, and which is secured between the end plate 220 and the casing 200 by the fasteners 220. To this end, the seal 230 includes openings 232 through mounting flanges 234 thereof that allow the threads of the fasteners 222 to pass through them before being secured in openings 210.

Seal 230 can be advantageously used to provide a fluidic seal between the casing 200 and the end plate 220, for example, if the casing 200 is used to contain a fluid when used in a two-stage rotary vane vacuum pump.

It is to be understood that although seal 230 is depicted as a gasket secured by fasteners, any other suitable seal arrangement could be used within the scope of this disclosure, such as for example, an O-ring seal. Moreover, the seal 230 can be made of any suitable material, such as a resilient material.

In known two-stage rotary vane vacuum pump casing designs, such as discussed under FIG. 1, the entire casing assembly 300 is cast as a single piece. This means the end of the casing 100 is not removable. In contrast, having the removable end plate 220 as provided in FIG. 6 provides significant advantages, as it makes getting access to the interior of the casing 200 (and any vacuum pump components it may be housing) more convenient than in other known designs, which facilitates pump maintenance and repair.

As shown in FIGS. 2 and 6, the end plate 220 includes a plurality of cooling fins 226 protruding from and extending along an exterior surface 221 of the end plate 220. Each of the cooling fins 226 aligns with a corresponding one of the casing cooling fins 204. In this respect, each of the cooling fins 226 extend axially along the direction of the longitudinal axis L, and are parallel and coaxial with a respective one of the cooling fins 204.

The cooling fins 226 are formed in parallel rows and are spaced apart by portions 221a of the end plate exterior surface 221. Due to the alignment of the cooling fins 226 with the cooling fins 204, the portions 221 axially align with the cooling channels 206 formed thereby in the same way.

The cooling fins 226 are formed as planar elements 228 that protrude perpendicularly from the exterior surface 221, but which also include a tapering portion 229 that tapers away from the casing 200 (i.e. taper axially away from the second casing end 201b/second cooling fin end 204b along the longitudinal axis L). The tapering portion 229 is shown as tapering the cooling fin 226 in both thickness (i.e. reducing in thickness transverse to longitudinal axis L) and also in height (i.e. reducing in height above the exterior surface 221).

It is to be appreciated that the cooling fins 226 may permit a smoother transition for cooling fluid to exit from the cooling fins 204 and disperse from the assembly 300. They may also allow some additional thermal transfer to take place between the end plate 220 and the cooling fluid exiting the cooling fins 204 than would otherwise occur. In addition, the alignment and tapering elements may also provide the casing assembly 300 with a better aesthetic. It is to be understood that the cooling fins 226 can be used equally with cooling fins 204 or 214 or combinations thereof, as specific applications require.

Referring to FIG. 7, a two-stage rotary vane vacuum pump 400 is shown in accordance with an embodiment of the present disclosure.

As is generally known, the pump 400 comprises a motor assembly 410 that is operatively connected to two rotary vane assembly stages (not shown). The rotary vane assembly stages are surrounded by (i.e. housed in) casing 200, and the along with the motor assembly 410 are secured to a mounting plate 450. The first rotary vane stage is fluidically connected to a fluid inlet 420 and an inlet for the second rotary vane stage. The second rotary vane stage is fluidically connected to the outlet of the first rotary vane stage and the fluid outlet 430. In this manner, the two rotary vane stages are connected in series between the fluid inlet 420 and the fluid outlet 430. Each stage of the rotary vane assembly defines a rotor that is rotationally offset (i.e. eccentrically mounted) within a compression chamber (not shown). Vanes are provided which protrude from the rotor to seal compartments between the rotor and the compression chamber. The motor assembly 410 rotates the rotary vane assembly, and the vanes interact with the compression chamber as it rotates to continuously suck in fluid to the compression chamber, compress the fluid, and then expel it from the compression chamber. In this manner, a vacuum can be generated using the pump 400 via connection to the inlet 420.

In order to provide the necessary lubrication to the rotary vane assembly, the casing 200 defines a chamber that is filled with oil. Accordingly, casing 200 is referred to in the art as an oil casing in such a two-stage rotary vane vacuum pump, as it is designed to retain lubrication oil therein. For this reason, pump 400 may be known in the art as a two-stage ‘oil-sealed’ rotary vane vacuum pump.

As discussed above in relation to FIG. 6, the end plate 220 is used to cap and seal the casing 200. The end plate 220 includes a transparent oil level window 440 that allows a user of the pump 400 to check the oil levels in the oil casing to make sure they are appropriate for the rotary vane assembly to operate properly. The pump 400 is also provided with oil inlets and outlets (not shown) to allow the chamber within casing 200 to be filled with oil and drained of oil (e.g. for oil replacement), as appropriate.

As the pump operates, the compression of the fluid and movement of the two-stage rotary vane assembly can generate heat that is transferred to the oil and casing 200 overtime. This can become a relatively large source of excess heat during pump operation, which is why it is particularly important for the casing 200 to have the cooling fin features discussed above.

Moreover, in certain designs, the motor assembly 410 may include a fan (not shown) that rotates with the motor assembly 410 to generate a cooling fluid flow that is directed axially along the longitudinal axis M of the motor assembly 410 towards the casing 200. In such arrangements, the cooling fin features of the casing 200 and/or end plate 220 can more effectively confine, guide and promote thermal transfer to this fluid from the casing 200 and oil therein.

Although the casing 200 and the end plate 220 of the present disclosure are particularly advantageous when used as an oil casing in a two-stage rotary vane vacuum pump, they may nevertheless find benefit when used as other casings in a two-stage rotary vane vacuum pump, for example, for motor assembly 410. All such suitable applications are envisaged within the scope of this disclosure.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A two-stage rotary vane vacuum pump casing comprising:
an exterior surface; and
a first plurality of cooling fins protruding from the exterior surface, wherein each cooling fin extends along the exterior surface between a first and second cooling fin end, and is a non-planar element that forms an at least partially enclosed cooling channel between the first and second ends of the cooling fin.

2. The casing of claim 1, wherein each cooling fin defines an overhang that extends over the exterior surface to form the at least partially enclosed cooling channel.

3. The casing of claim 1, wherein the cross-section of the cooling fins viewed along the exterior surface is at least one of a T-shape or an L-shape.

4. The casing of claim 1, wherein the cooling fins define fully enclosed cooling channels that are tubular.

5. The casing of claim 4, wherein the cross-section of the fully enclosed cooling channels viewed along the exterior surface is at least one of a regular closed shape, for example, circular, square or hexagonal shaped, or an irregular closed shape, for example, a concave or convex irregular shape.

6. The casing of claim 1, wherein the cooling fins extend along the exterior surface in a series of rows parallel to each other.

7. The casing of claim 6, wherein the rows of cooling fins extend parallel to a longitudinal axis of the casing from a first end of the casing to an opposing second end of the casing.

8. A two-stage rotary vane vacuum pump casing assembly comprising:
the casing of claim 1; and
an end plate removably secured to the casing at a/the second casing end.

9. The casing assembly of claim 8, further comprising a seal secured between the end plate and the second casing end.

10. The casing assembly of claim 8, wherein the end plate further comprises a second plurality of cooling fins protruding from and extending along an exterior surface of the end plate, and wherein the second plurality of cooling fins align axially with the first plurality of cooling fins.

11. The casing assembly of claim 10, wherein the second plurality of cooling fins are planar elements that have a tapering portion that tapers away from the casing.

12. The casing assembly of claim 8, wherein the end plate comprises a transparent window for checking an oil level.

13. A two-stage rotary vane vacuum pump comprising:
a two-stage rotary vane assembly; and
the casing or casing assembly of claim 1, wherein the casing is an oil casing that surrounds the two-stage rotary vane assembly.

14. A method of manufacturing a two-stage rotary vane vacuum pump casing comprising forming the casing by extrusion.

15. A method of manufacturing a two-stage rotary vane vacuum pump casing comprising forming the casing by extrusion wherein the step of forming the casing includes forming the casing in accordance with claim 1.

16. The method of claim 14, wherein the casing is an oil casing for a two-stage rotary vane vacuum pump.

17. A two-stage rotary vane vacuum pump casing comprising a removably attached end plate.

18. The casing of claim 17, wherein the end plate is removably attached with fasteners and includes openings for receiving the fasteners.

19. The casing of claim 17, wherein the end plate comprises a plurality of cooling fins protruding from and extending along an exterior surface of the end plate.

20. The casing of claim 19, wherein the cooling fins are planar elements that have a tapering portion that tapers in an axial direction of the end plate.

21. The casing of claim 17, wherein the casing is an oil casing for a two-stage rotary vane vacuum pump.

22. The casing of claim 17, wherein the end plate comprises a transparent window for checking an oil level.
